(19) United States
(12) Patent Application Publication
(10) Pub. No.: US 2007/0275327 A1
(43) Pub. Date: Nov. 29, 2007

(54) PHOTOSENSITIVE RESIN COMPOSITION, RESIST PATTERN FORMING METHOD, SUBSTRATE PROCESSING METHOD, AND DEVICE MANUFACTURING METHOD

(75) Inventors: Toshiki Ito, Kawasaki-shi (JP); Takako Yamaguchi, Atsugi-shi (JP)

Correspondence Address: FITZPATRICK CELLA HARPER & SCINTO, 30 ROCKEFELLER PLAZA, NEW YORK, NY, 10112, US

(73) Assignee: CANON KABUSHIKI KAISHA, Tokyo (JP)

(21) Appl. No.: 11/778,761

(22) Filed: Jul. 17, 2007

Related U.S. Application Data
(62) Division of application No. 11/084,041, filed on Mar. 21, 2005.

(30) Foreign Application Priority Data
Mar. 22, 2004 (JP) 083234/2004
Mar. 22, 2004 (JP) 083353/2004
Jul. 27, 2004 (JP) 219144/2004

(51) Int. Cl. G03C 5/00

(52) U.S. Cl. 430/291; 430/328; 430/329

(57) ABSTRACT

A photosensitive resin composition is constituted by a polymer, as a component (A), having a monodisperse molecular weight distribution; and a compound, as a component (B), first generating a functional group which is capable of being silylated by radiation irradiation.

### FIELD OF THE INVENTION AND RELATED ART

The present invention relates to a photosensitive resin composition, a method of forming a resist pattern, a method of processing a substrate, and a device manufacturing method. Particularly, the present invention relates to a photosensitive resin composition (resist) and a method of forming a resist pattern using the resist.

In recent years, demands for high density and high integration of devices have been increasing more and more in the fields of various electronic devices, requiring microprocessing, represented by a semiconductor device. In order to satisfy the demands, fine pattern formation has become essential. In a production process of such a semiconductor device, photolithography plays an important role in forming a fine pattern.

In a photolithographic step, a single-layer resist has been conventionally used. However, the use of the single-layer resist is liable to increase a difference in level or an inclination of a substrate with a higher integration and to reduce a depth of focus with a shorter wavelength and larger numerical aperture of a light source in order to realize finer design rules. In these circumstances, it has become difficult to accurately form a thick resist pattern with a high aspect ratio.

For this reason, in order to solve such a problem, a surface-layer imaging process has been proposed. In this surface-layer imaging process, only a surface of a resist having a single-layer structure or a multi-layer structure is exposed to light and as desired, subjected to wet development, thus selectively forming a pattern highly resistant to oxygen dry etching at the resist surface. By using the resultant pattern as a mask, dry (etching) development of a lower layer portion is performed with oxygen plasma.

According to the surface-layer imaging process, only the resist surface is subjected to photoreaction, so that it is possible to use an exposure apparatus having a shallow depth of focus. Further, the process is not readily adversely affected by light reflection from the substrate and the difference in level of the substrate. Further, the dry etching has a high anisotropy, so that it is possible to form a resist pattern with a high aspect ratio. In addition thereto, the process has also advantages that the resultant pattern is not destroyed at the time of development and rinsing and that there are no influences of impurities in the developing liquid and deterioration.

As the above described surface-layer imaging process, several proposals represented by a multi-layer resist process and a sylylation process have been made.

For example, as the multi-layer resist process, a bilayer (two-layer) resist process has been described in U.S. Patent Application Publication No. US2003/0073040 A1 (corresponding to Japanese Laid-Open Patent Application (JP-A) No. 2003-149820). This bilayer resist process is such a process that a silicon-containing resist which is capable of being developed with alkali and is resistant to oxygen dry etching is laminated on a lower thermoset layer film and then is subjected to pattern exposure, heating (after the exposure), and alkali development to form an upper layer pattern. Thereafter, the upper layer pattern is transferred onto the lower layer film by dry etching with oxygen plasma.

Further, as the above described sylylation process, JP-A No. Hei 11-282165 has disclosed a sylylation process wherein a functional group to be sylylated such as hydroxyl group, carboxyl group, amino group, thiol group, or amido group is selectively generated at either one of an exposure portion and a non-exposure portion by exposure and heat treatment which is performed as desired and then is converted into silyl ether with a sylylating agent and subjected to dry development with oxygen plasma to form a pattern. In addition, Diffusion Enhanced Sylylating Resist (DESIRE) process has also been proposed by F. Coopmeans and B. Roland is Sold State Technology, vol. 93, June (1987). In this DESIRE process, a resist comprising a naphthoquinone diazido-containing compound and novolac resin is subjected to pattern exposure and heating to be selectively sylylated with a sylylating agent only at a surface layer of an exposure portion thereof and then is subjected to dry etching with oxygen plasma to form a pattern.

In the above described two-layer resist process, as an upper layer resist, a silicon-containing resist is required but is accompanied with such a problem that the silicon-containing resist has a low resolution to provide a large line edge roughness. Further, there also arises a problem in terms of complicated process.

In the DESIRE process described above, hydroxyl group is also present at the non-exposure portion, so that the DESIRE process is accompanied with problems such as a low contrast for sylylation resulting in sufficient resolution and a large line edge roughness.

Incidentally, herein, the line edge roughness is defined by a line pattern width 3 σ as measured by a scanning electron microscope, an atomic force microscope, or the like.

Generally speaking, an allowable line edge roughness in device manufacturing with a design rule of not more than 100 nm L/S is approximately 5 nm. However, the pattern formed through the above-described conventional resist process has a line edge process of approximately 10 nm.

### SUMMARY OF THE INVENTION

An object of the present invention is to provide a photosensitive resin composition capable of forming a high-resolution resist pattern with a low line edge roughness through a simple process and being used in dry development.

Another object of the present invention is to provide a method of forming a resist pattern, a method of processing a substrate, and a device manufacturing method, using the above described photosensitive resin composition.

According to a first aspect of the present invention, there is provided a photosensitive resin composition, comprising:

a polymer, as a component (A), having a monodisperse molecular weight distribution, and

a compound, as a component (B), first generating a functional group which is capable of being sylylated by radiation irradiation.

In the photosensitive resin composition, the polymer as the component (A) may preferably have a weight-average molecular weight (Mw) of 1,000-50,000 in polystyrene conversion, and the monodisperse molecular weight distribution may preferably comprise a molecular weight dispersion of weight-average molecular weight to number-average molecular weight (Mw/Mn) of 1.0-1.5 in polystyrene conversion. Further, it is preferable that the polymer as the component (A) does not contain a functional group capable of being silylated by radiation irradiation. The polymer as the component (A) may preferably be polystyrene. In the photosensitive resin composition, the compound as the component (B) may preferably be a compound which generates at least one of hydroxyl group, carboxyl group, amino group, thiol group, and amido group, by radiation irradiation.

A method of forming a resist pattern according to the present invention is characterized by including: a lamination step of laminating on a substrate a layer of the photosensitive resin composition described above or a layer of the compound as the component (B) alone, an exposure step of selectively exposing the photosensitive resin composition layer to radiation to form an exposure portion, a sylylation step of sylylating the exposure portion with a sylylating agent, and a developing step of removing the photosensitive resin composition layer through dry etching with oxygen plasma while leaving a sylylated area.

A method of processing a substrate according to the present invention is characterized by including: a step of forming a resist pattern on a work substrate, to be processed, by the method of forming a resist pattern described above, and a step of effecting dry etching, wet etching, metal vapor deposition, life-off, or plating with respect to the work substrate on which the resist pattern is formed in the above step.

A device manufacturing method according to the present invention is characterized by including: a step of preparing an exposure mask on which a pattern is formed on the basis of device designing, and a step of forming a pattern on a substrate, for manufacturing a device, by the method of processing a substrate described above.

According to a second aspect of the present invention, there is provided a photosensitive resin composition, comprising: a polymer, as a component (A), having a monodisperse molecular weight; a radiation-sensitive acid generation agent as a component (C); and a compound, as a component (D), containing at least one functional group selected from the group consisting of hydroxyl group, carboxyl group, amino group, thiol group, and amido group, each of which is protected by an acid-dissociative group.

A method of forming a resist pattern according to the present invention is characterized by including: a lamination step of laminating on a substrate a layer of the photosensitive resin composition described above, an exposure step of exposing a predetermined portion of the photosensitive resin composition layer to active light ray to form an exposure portion, a sylylation step of sylylating the exposure portion, and a dry development step of removing a portion other than the exposure portion of the photosensitive resin composition layer by oxygen plasma.

According to the present invention, it is possible to realize a photosensitive resin composition which can form a high-resolution resist pattern with a low line edge roughness and can be used in dry development. Further, it is also possible to realize a resist pattern forming method, a substrate processing method, and a device manufacturing method, using the photosensitive resin composition.

These and other objects, features and advantages of the present invention will become more apparent upon a consideration of the following description of the preferred embodiments of the present invention.

### DETAILED DESCRIPTION OF THE PREFERRED EMBODIMENTS

Hereinbelow, Embodiments of the present invention will be described in detail.

A first embodiment of a photosensitive resin composition according to the first aspect of the present invention will be explained.

The photosensitive resin composition contains the components (A) and (B) described above and is capable of providing a high resolution (resolving power) and a high aspect ratio.

By using a photosensitive resin composition (hereinafter, simply referred to as a “resist”), it becomes possible to form a resist pattern which is low (small) in line edge roughness (“LER”) and high in aspect ratio through a surface imaging with arbitrary exposure method and subsequent selective sylylation process and dry development.

In this embodiment, as the polymer for the component (A), e.g., it is possible to use acrylic-based resin, styrene-based resin, epoxy-based resin, amide-based resin, amide-epoxy-based resin, alkyd-based resin, phenol-based resin, and the like. Of these resins, it is preferable that they does not contain hydroxyl group, carboxyl group, amino group, thiol group, and amido group but contain aromatic group, particularly be polystyrene. This is because when the resin has a functional group capable of being sylylated, such as hydroxyl group, carboxyl group, amino group, thiol group, or amido group, a sylylation contrast is low, thus resulting in a low resolution. On the other hand, an aromatic group-containing polymer has a high resistance to dry etching at the time of processing a (supporting) substrate, thus being excellent in processing margin.

In the present invention, the polymer as the component (A) may preferably have an Mw(weight-average molecular weight) of 1,000-50,000, more preferably 1,000-30,000, particularly preferably 1,000-20,000. When the Mw is less than 1,000, there arise problems that a film-forming property is low and a resistance to dry etching at the time of processing the substrate becomes low. When the Mw exceeds 50,000, the resultant LER is high (large).

Incidentally, in the present invention, the Mw and the Mn (number-average molecular weight) are those measured by gel permeation chromatography and obtained through standard polystyrene conversion.

Further, the polymer as the component (A) may preferably have the molecular weight dispersion (Mw/Mn) of 1.0-1.5, more preferably 1.0-1.2, particularly preferably 1.0-1.1. When the molecular weight dispersion exceeds 1.5, the resultant LER is large.

When the weight-average molecular weight (Mw) and the molecular weight dispersion (Mw/Mn) are small, the component (B) as an agent to be sylylated is dispersed uniformly and closely. Further, a permeation speed of the sylylating agent and a sylylation reaction speed vary depending on an average molecular weight of the system. For this reason, when the molecular weight dispersion of the component (A) is small, a sylylation ratio of the component (B) leading to a spatial distribution of a resistance to oxygen dry etching is also small. Accordingly, in the present invention, a resist pattern having a small LER is formed. Polystyrene having the molecular weight dispersion of 1.0-1.5 as the component (A) may be synthesized through known living anionic polymerization. The Mw of the polystyrene (component (A)) is readily controlled in the living anionic polymerization by adjusting a weight of monomer and the number of moles of initiator.

As the above described component (B), it is possible to use any compound so long as it generates first at least one species of functional groups selected from the group consisting of hydroxyl group, carboxyl group, amino group, thiol group, and amide group, through light irradiation. In the present invention, however, a compound having 1,2-naphthoquinone diazido group may particularly preferably be used.

As the 1,2-naphthoquinone diazido group-containing compound, it is possible to use various known compounds therefore, particularly esters of various hydroxy compounds with 1,2-naphthoquinone diazido sulfonic acid.

Examples of the hydroxy compounds may include: polyhydroxybenzophenones, such as 2,3,4-trihydroxybenzophenone; 2,4,4′-trihydroxybenzophenone; 2,4,6-trihydroxybenzophenone; 2,3,4,4′-tetrahydroxy-benzophenone; 2,2′,4,4′-tetrahydroxybenzophenone; 2,3′,4,4′,6-pentahydroxybenzophenone; 2,2′,3,4,4′-pentahydroxybenzophenone; 2,2′,3,4,5′-pentahydroxybenzophenone; 2,3′,4,5,5′-pentahydroxybenzophenone; and 2,3,3′,4,4′,5-hexahydroxybenzophenone; and mono-functional and poly-functional phenols, such as phenol, p-methoxy phenol, dimethylphenol, hydroquinone, bisphenol A, bisphenol F, bisphenol Z, triphenol alkane, naphthol, pyracatechol, pyragallol monomethyl ether, pyragallol-1,3-dimethyl ether, gallic acid, partially esterified gallic acid, and partially etherified gallic acid.

The above described 1,2-naphthoquinone diazido compounds may, e.g., be produced by subjecting 1,2-naphthoquinone diazido sulfonic acid halide and the above described hydroxy compound to condensation reaction and then by completely or partially esterifying the resultant condensation compound. Examples of the 1,2-naphthoquinone diazido sulfonic halide may include 1,2-naphthoquinone-2-diazido-5-sulfonyl chloride and 1,2-naphthoquinone-2-diazido-4-sulfonyl chloride. The condensation reaction is effectively performed ordinarily in an organic solvent, such as dioxane, N-methyl-2-pyrrolidone, or dimethylacetamide, in the presence of a basic condensation agent, such as triethanolamine, carbonaten alkali, or hydrogen carbonate alkali. In this case, it is preferred to use an ester obtained through condensation by adding, e.g., naphthoquinone-1,2-diazido-4 (or -5)-sulfonyl halide in an amount corresponding to the number of moles which is 0.8-1.2 times, preferably 0.9-1.1 times a total number of moles of hydroxyl groups of the hydroxy compound (i.e., in an amount providing an esterification degree of not less than 80%, preferably not less than 90%) because it is possible to obtain a higher resolution.

Incidentally, a part of hydroxyl groups of the hydroxy compound may be esterified with a sulfonyl halide compound other than the naphthoquinone diazido sulfonyl halide compound. More specifically, examples of such a sulfonyl halide compound may include: alkane sulfonyl halides having 1-12 carbon atoms, such as methane sulfonyl chloride, methane sulfonyl fluoride, ethane sulfonyl chloride, n-propane sulfonyl chloride, n-butane sulfonyl chloride, pentane sulfonyl chloride, and dodecane sulfonyl chloride; substituted alkane sulfonyl halides having 1-12 carbon atoms, such as chloromethylsulfonyl chloride, dichloromethylsulfonyl chloride, trichloromethylsulfonyl chloride, and 2-chloroethylsulfonyl chloride; alkene sulfonyl halides having 2 and 3 carbon atoms, such as ethylene sulfonyl chloride and 1-propene-1-sulfonyl chloride; aryl sulfonyl halides, such as benzene sulfonyl chloride, benzyl sulfonyl chloride, and 1-naphthalene sulfonyl chloride; alkyl-, alkenyl-, and alkoxy-substituted aryl sulfonyl halide, such as p-toluene sulfonyl chloride, p-ethylbenzene sulfonyl chloride, p-styrene sulfonyl chloride, and p-methoxy benzyl sulfonyl chloride; and an esterified compound between a naphthoquinone diazido sulfonyl halide compound and a hydroxy compound.

Of the above described esterified compounds, the 1,2-naphthoquinone diazido sulfonyl ester compounds using triphenolmethane, bisphenol A, etc.

The resist of the present invention may further contain known additives, as desired, such as a coloring agent, an adhesive aid, a storage stabilizer, an antifoaming agent, and the like.

Next, contents of the respective components of the resist in this embodiment will be described.

The component (A) may preferably be contained in an amount of 10-70 wt. parts, more preferably 25-50 wt. parts, per 100 wt. parts as a total amount of the component (A) and the component (B). When the amount of the component (A) exceeds 70 wt. parts, a resultant photosensitivity is liable to be lowered.

The component (B) may preferably be contained in an amount of 30-90 wt. parts, more preferably 50-70 wt. parts, per 100 wt. parts as a total amount of the component (A) and the component (B). When the amount of the component (B) is less than 30 wt. parts, a resultant photosensitivity is liable to be lowered.

The resist in this embodiment is, when it is used, dissolved in a solvent, e.g., at a solid concentration of 2-50 wt. % and filtered through a filter with a pore size of approximately 0.1-0.2 microns to be prepared as a composition solution. The solvent may be basically any solvent so long as it can solve both the component (A) and the component (B), and can be selected depending on a purpose of the resist. As the solvent, it is possible to use ethers, esters, ether esters, ketones, ketone esters, amides, amido esters, lactams, lactons, (halogenated) hydrocarbons, etc. Examples thereof may include: ethylene glycol monoalkyl ethers, diethylene glycol dialkyl ethers, ethylene glycol monoalkyl ether acetates, propylene glycol monoalkyl ether acetates, propylene glycol monoalkyl ethers, propylene glycol dialkyl ethers, acetates, hydroxy acetates, lactates, alkoxy acetates, (non-)cyclic ketones, acetoacetates, pyruvates, propionates, N,N-dialkylformamides, N,N-dialkylacetamides, N-alkyl pyrrolidones, γ-lactones, (halogenated) aliphatic hydrocarbons, and (hydrogenated) aromatic hydrocarbons.

Specific examples of such a solvent may include: ethylene glycol monomethyl ether, ethylene glycol monoethyl ether, ethylene glycol mono-n-propyl ether, ethylene glycol mono-n-butyl ether, diethylene glycol dimethyl ether, diethylene glycol diethyl ether, diethylene glycol di-n-propyl ether, diethylene glycol di-n-butyl ether, ethylene glycol monomethyl ether acetate, ethylene glycol monoethyl ether acetate, ethylene glycol mono-n-propyl ether acetate, propylene glycol monomethyl ether acetate (PGMEA), polylene glycol monoethyl ether acetate, propylene glycol mono-n-propyl ether acetate, isopropenyl acetate, isopropenyl propionate, toluene, xylene, methyl ethyl ketone, cyclohexane, 2-heptanone, 3-heptanone, 4-heptanone, ethyl 2-hydroxypropionate, ethyl-2-hydroxy-2-methylpropionate, ethoxy ethyl acetate, hydroxy ethyl acetate, methyl-2-hydroxy-3-methylbutyrate, 3-methoxybutyl acetate, 3-methyl-3-methoxybutyl acetate, 3-methyl-3-methoxybutyl propionate, 3-methyl-3-methoxybutyl butylate, ethyl acetate, n-propyl acetate, n-butyl acetate, methyl acetoacetate, ethyl acetoacetate, methyl-3-methoxypropionate, ethyl-3-methoxypropionate, ethyl-3-ethoxypropionate, N-methyl-2-pyrrolidone, N,N-dimethylformamide, N,N-dimethylacetamide, etc. Of these solvents, in view of safety, it is desirable that propylene glycol monomethyl ether acetate (PGMEA), ethyl-2-hydroxypropionate, and cyclohexane are used. These solvents may be used singly or in combination of two or more species.

To the above described solvents, it is also possible to add, as desired, one or more species of high-boiling point solvents, such as benzyl ethyl ether, di-n-hexyl ether, diethylene glycol monomethyl ether, diethylene glycol monoethyl ether, acetonyl acetone, isophoron, caproic acid, capric acid, 1-octanol, 1-nonanol, benzyl alcohol, benzyl acetate, ethyl benzoate, diethyl oxalate, diethyl maleate, γ-butyrolactone, ethylene carbonate, propylene carbonate, and ethylene glycol monophenyl acetate.

The above described resist solution may be applied by known application (coating) apparatus (and method), such as a spin coater, a dip coater, a roller coater, or the like. A thickness of the resist (film) may be set, as desired, depending on the uses of the resist, but may be set generally so as to be 0.1-5 microns after pre-baking. The applied resist film (layer) is pre-baked at 80-150° C., preferably 80-110° C., by a heating means such as a hot plate, a hot air drier, or the like. The resist layer after completion of the coating is ordinarily exposed to light imagewise through a reticle by a known exposure apparatus. As a light source for the exposure apparatus, it is possible to use a known light source, such as a carbon arc lamp, a mercury vapor arc lamp, a high-pressure mercury lamp, a xenon lamp, an Ar ion laser, a semiconductor laser, an excimer laser, or visible radiation. The light source used in the present invention generates radiation, in a broad sense, such as electromagnetic wave or corpuscular beam. More specifically, the light source used in the present invention embraces those generating infrared radiation, visible radiation, ultraviolet radiation, f or ultraviolet radiation, X-rays, and electron beam.

By the exposure, a functional group capable of being sylylated is generated only at an exposure portion of the resist according to the present invention. For this reason, the imagewise exposed resist is selectively sylylated at a surface layer portion of the exposure portion by a sylylation process described later. Incidentally, the functional group, capable of being sylylated, generated in the present invention is carboxyl group of indene carboxylic acid.

The sylylation process may be arbitrarily performed through a known vapor-phase or liquid-phase method. As a sylylating agent, a compound represented by a general formula:
RₙSiX₍₄₋ₙ₎,
wherein X represents a hydrolyzable group, such as halogen atom, alkoxy group, acyloxy group, or amino group; and R represents a non-hydrolyzable hydrocarbon group or hydrogen atom. Examples of the compound may include known compounds inclusive of an alkoxysilane compound, such as n-propyltriethoxysilane; a chlorosilane compound, such as vinyltrichlorosilane; and a silazane compound, such as hexamethyldisilazane. In the case of the performing the vapor-phase sylylation, the resist layer is exposed to vapor of the sylylating agent. The liquid-phase sylylation is performed by immersing the resist layer in a solution of the sylylating agent. These processes are performed for 0.1-30 minutes at 25-180° C.

After the sylylation, dry development is effected by using the sylylated surface layer portion of the exposure portion as a mask. The dry development is performed by plasma etching using oxygen-containing gas. By the dry development, an unexposed portion is removed and a negative resist pattern. As the oxygen-containing gas, it is possible to use oxygen gas alone; mixed gas of oxygen with inert gas, such as argon; and mixed gases of oxygen with another gas, such as carbon monoxide, carbon dioxide, ammonia, nitrous oxide, or sulfur dioxide.

With the use of the above formed resist pattern as a mask, a substrate is processed by dry etching, wet etching, metal (vapor) deposition, light-off, or plating to produce a desired device.

More specifically, e.g., a semiconductor device is manufactured in the following manner.

After circuit design of the semiconductor device is made, on the basis of the circuit design, a mask on which a circuit pattern is formed is prepared. On a substrate for the device (e.g., a silicon wafer), a photosensitive resin composition of the present invention is laminated. Then, by using the above prepared mask and an ordinarily used exposure apparatus, a circuit is formed through lithography. More specifically, at the time of circuit formation, formation of an oxide film, etching, formation of an insulating film, formation of a wiring electroconductive film, patterning, and so on are performed. Thereafter, the circuit formed substrate is subjected to an assembly step (dicing, bonding), a packing step, etc., to be constructed in a chip form.

Next, a second embodiment of a photosensitive resin composition according to the second aspect of the present invention will be described.

The photosensitive resin composition in this embodiment is characterized by containing a polymer, as a component (A), having a monodisperse molecular weight; a radiation-sensitive acid generation agent as a component (C); and a compound, as a component (D), containing at least one functional group selected from the group consisting of hydroxyl group, carboxyl group, amino group, thiol group, and amido group, each of which is protected by an acid-dissociative group.

In this embodiment, the component (A) is the same as in the first embodiment described above.

The radiation-sensitive acid generation agent (hereinafter referred to as a “photoacid generator”) is a compound which includes chemical reaction by irradiation of radiation such as infrared radiation, visible radiation, ultraviolet radiation, 4 t for ultraviolet radiation, X-rays, charged particle beam such as electron beam, thus producing an acid. As such a photoacid generator, it is possible to use an anium salt compound, a sulfone compound, a sulfonate compound, a sulfonimide compound, a diazomethane compound, etc. In the present invention, the onium salt compound is preferred.

As the onium salt, it is possible to use, e.g., iodomium salt, sulfonium salt, phosphonium salt, diazonium salt, pyridinium salt, etc. Specific examples of the onium salt compound may include: bis-(4-t-butylphenyl)iodoniumfluoro-n-butane sulfonate, bis-(4-t-butylphenyl)iodoniumtrifluoromethane sulfonate, bis-(4-t-butylphenyl)iodonium-2-trifluoromethylbenzene sulfonate, bis-(4-t-butylphenyl)iodoniumpyrene sulfonate, bis-(4-t-butylphenyl)iodonium-n-dodecylbenzene sulfonate, bis-(4-t-butylphenyl)iodonium-p-toluene sulfonate, bis-(4-t-butylphenyl)-iodoniumbenzene sulfonate, bis-(4-t-butylphenyl)iodonium-10-camphor sulfonate, bi-(4-t-butylphenyl)iodonium-n-octane sulfonate, diphenyliodoniumperfluoro-n-butane sulfonate, diphenyliodoniumtrifluoromethane sulfonate, diphenyliodonium-2-trifluoromethylbenzene sulfonate, diphenyliodonium-pyrene sulfonate, diphenyliodonium-n-dodecylbenzene sulfonate, diphenyliodonium-p-toluene sulfonate, diphenyliodoniumbenzene sulfonate, diphenyliodonium-10-camphor sulfonate, diphenyl-iodonium-n-octane sulfonate, triphenylsulfoniumper-fluoro-n-butane sulfonate, triphenylsulfonium-trifluoromethane sulfonate, triphenylsulfonium-2-trifluoromethylbenzene sulfonate, triphenylsulfoniumpyrene sulfonate, triphenylsulfonium-n-dodecylbenzene sulfonate, triphenylsulfonium-p-toluene sulfonate, triphenylsolfoniumbenzene sulfonate, triphenylsulfonium-10-camphor sulfonate, triphenylsulfonium-n-octane sulfonate, diphenyl(4-t-butylphenyl)sulfoniumperfluoro-n-butane sulfonate, diphenyl(4-t-butylphenyl)sulfoniumtrifluoromethane sulfonate, diphenyl(4-t-butylphenyl)sulfonium-2-trifluoromethylbenzene sulfonate, diphenyl(4-t-butylphenyl)sulfoniumpyrene sulfonate, diphenyl(4-t-butylphenyl)sulfonium-n-dodecylbenzene sulfonate, diphenyl(4-t-butylphenyl)sulfonium-p-toluene sulfonate, diphenyl(4-t-butylphenyl)sulfoniumbenzene sulfonate, diphenyl(4-t-butylphenyl)sulfonium-10-camphor sulfonate, diphenyl(4-t-butylphenyl)sulfonium-n-octane sulfonate, tris-(4-t-butylphenyl)-sulfoniumfluoro-n-butane sulfonate, tris-(4-t-butylphenyl)sulfoniumtrifluoromethane sulfonate, tris-(4-t-butylphenyl)sulfonium-2-trifluoromethylbenzene sulfonate, tris-(4-t-butylphenyl)sulfoniumpyrene sulfonate, tris-(4-t-butylphenyl)sulfonium-n-dodecylbenzene sulfonate, tris-(4-t-butylphenyl)sulfonium-p-toluene sulfonate, tris-(4-t-butylphenyl)sulfoniumbenzene sulfonate, tris-(4-t-butylphenyl)sulfonium-10-camphor sulfonate, and tris-(4-t-butylphenyl)sulfonium-n-octane sulfonate.

As the sulfone compound, it is possible to use, e.g., β-ketosulfone, β-sulfonyl sulfone, and their α-diazo compounds. Examples thereof may include phenacylphenyl sulfone, mesitylphenacyl sulfone, bis(phenylsulfonyl)methane, 4-trisphenacyl sulfone, etc.

As the sulfonate compound, it is possible to use, e.g., alkyl sulfonate, haloalkyl sulfonate, aryl sulfonate, and imino sulfonate. Examples thereof may include α-methylolbenzoin perfluoro-n-butane sulfonate, α-methylbenzoin trifluoromethane sulfonate, 2-methylolbenzoin-2-trifluoromethylbenzene sulfonate.

Specific examples of the sulfonimide compound may include: N-(trifluoromethylsulfonyloxy)-succinimide, N-(trifluoromethylsulfonyloxy)-phthalimide, N-(trifluoromethylsulfonyloxy)-diphenylmaleimide, N-(trifluoromethylsulfonyloxy)-bicyclo[2.2.1]hepto-5-ene-2,3-dicarboxyimide, N-(trifluoromethylsulfonyloxy)-7-oxabicyclo[2.2.1]-hepto-5-ene-2,3-dicarboxyimide, N-(trifluoromethyl-sulfonyloxy)bicyclo[2.2.1]heptane-5,6-oxy-2,3-dicarboxyimide, N-(trifluoromethylsulfonyloxy)-naphthylimide, N-(10-camphorsulfonyloxy)succinimide, N-(10-camphorsulfonyloxy)phthalimide, N-(10-camphorsulfonyloxy)diphenylmaleimide, N-(10-camphorsulfonyloxy)bicyclo[2.2.1]hepto-5-ene-2,3 -dicarboxyimide, N-(10-camphorsulfonyloxy)-7-oxabicyclo[2.2.1]hepto-5-ene-2,3-dicarboxyimide, N-(10-camphorsulfonyloxy)bicyclo[2.2.1]heptane-5,6-oxy-2,3-dicarboxyimide, N-(10-camphorsulfonyloxy)-naphthylimide, N-(4-methylphenylsulfonyloxy)-succinimide, N-(4-methylphenylsulfonyloxy)-phthalimide, N-(4-methylphenylsulfonyloxy)-diphenylmaleimide, N-(4-methylphenylsulfonyloxy)-bicyclo[2.2.1]hepto-5-ene-2,3-dicarboxyimide, N-(4-methylphenylsulfonyloxy)-7-oxabicyclo[2.2.1]-hepto-5-ene-2,3-dicarboxyimide, N-(4-methylphenylsulfonyloxy)-bicyclo[2.2.1]heptane-5,6-oxy-2,3-dicarboxyimide, N-(4-methylphenylsulfonyloxy)-naphthylimide, N-(2-trifluoromethylphenylsulfonyloxy)succinimide, N-(2-trifluoromethylphenylsulfonyloxy)phthalimide, N-(2-trifluoromethylphenylsulfonyloxy)diphenylmaleimide, N-(2-trifluoromethylphenylsulfonyloxy)bicyclo[2.2.1]-hepto-5-ene-2,3-dicarboxyimide, N-(2-trifluoromethyl-phenylsulfonyloxy)-7-oxabicyclo[2.2.1]hepto-5-ene-2,3-dicarboxyimide, N-(2-trifluoromethylphenyl-sulfonyloxy)bicyclo[2.2.1]heptane-5,6-oxy-2,3-dicarboxyimide, N-(2-trifluoromethylphenyl-sulfonyloxy)-naphthylimide, N-(4-fluorophenyl-sulfonyloxy)succinimide, N-(4-fluorophenylsulfonyl-oxy)phthalimide, N-(4-fluorophenylsulfonyloxy)-diphenylmaleimide, N-(4-fluorophenylsulfonyloxy)-bicyclo[2.2.1]hepto-5-ene-2,3-dicarboxyimide, N-(4-fluorophenylsulfonyloxy)-7-oxabicyclo[2.2.1]hepto-5-ene-2,3-dicarboxyimide, N-(4-fluorophenylsulfonyloxy)-bicyclo[2.2.1]heptane-5,6-oxy-2,3-dicarboxyimide, N-(4-fluorophenylsulfonyloxy)-naphthylimide.

Specific examples of the diazomethane compound may include: bis(trifluoromethylsulfonyl)-diazomethane, bis(cyclohexylsulfonyl)diazomethane, bis(phenylsulfonyl)diazomethane, bis(p-toluene-sulfonyl)diazomethane, methylsulfonyl-p-toluene-sulfonyl diazomethane, (cyclohexylsulfonyl)(1,1-dimethylethylsulfonyl)diazomethane, and bis(1,1-dimethylethylsulfonyl)diazomethane.

Of these acid generation agents, the onium salt compound is preferred. The acid generation agents can be used singly or in mixture of two or more species in the present invention.

The above described compound as the component (D) contains one or more functional group, per molecule, selected from the group consisting of hydroxyl group, carboxyl group, amino group, thiol group, and amido group, each of which is protected by an acid-dissociative group, and may be a low-molecular weight compound or a polymeric compound.

As the acid-dissociative group of the component (D) may, e.g., include substituted methyl group, 1-substituted ethyl group, 1-branched alkyl group, alkoxycarbonyl group, acyl group, cyclic acid-dissociative group, etc.

Examples of substituted methyl group may include: methoxymethyl group, methylthiomethyl group, ethoxymethyl group, ethylthiomethyl group, methoxy-ethoxymethyl group, benzyloxymethyl group, benzyl-thiomethyl group, phenacyl group, p-bromophenacyl group, p-methoxyphenacyl group, p-methylthiophenacyl group, α-methylphenacyl group, cyclopropylmethyl group, benzyl group, diphenylmethyl group, triphenylmethyl group, p-bromobenzyl group, p-nitrobenzyl group, p-methoxybenzyl group, p-methylthiobenzyl group, p-ethoxybenzyl group, p-ethylthiobenzyl group, piperonyl group, methoxy-carbonylmethyl group, ethoxycarbonylmethyl group, n-propoxycarbonylmethyl group, i-propoxycarbonylmethyl group, i-propoxycarbonylmethyl group, n-butoxy-carbonylmethyl group, and t-butoxycarbonylmethyl group.

Examples of 1-substituted ethyl group may include: 1-methoxymethyl group, 1-methylthiethyl group, 1-ethoxymethyl group, 1-ethylthioethyl group, 1,1-diethoxyethyl group, 1-phenoxymethyl group, 1-phenylthioethyl group, 1,1-diphenoxyethyl group, 1-benzyloxyethyl group, 1-benzylthioethyl group, 1-cyclopropylethyl group, 1-phenylethyl group, 1,1-diphenylethyl group, 1-methoxycarbonylethyl group, 1-ethoxycarbonylethyl group, 1-n-propoxycarbonylethyl group, 1-i-propoxycarbonylethyl group, 1-i-propoxycarbonylethyl group, 1-n-butoxycarbonylethyl group, and 1-t-butoxycarbonylethyl group.

Examples of the 1-branched alkyl group may include: i-propyl group, sec-butyl group, t-butyl group, 1,1-dimethyl group, 1-methylbutyl group, and 1,1-dimethylbutyl group.

Examples of the alkoxycarbonyl group may include: methoxycarbonyl group, ethoxycarbonyl group, i-propoxycarbonyl group, and t-butoxycarbonyl group.

Examples of the acyl group may include: acetyl group, propionyl, butyryl group, heptanoyl group, hexanoyl group, valeryl group, pivaloyl group, isovaleryl group, lauroyl group, myristoyl group, palmitoyl group, stearoyl group, oxalyl group, malonyl group, succinyl group, glutaryl group, adipoyl group, piperoyl group, suberoyl group, azelaoyl group, sebacoyl group, acryloyl group, propioloyl group, methacryloyl group, crotonoyl group, oleoyl group, maleoyl group, fumaloyl group, mesaconoyl group, camphoroyl group, benzoyl group, phthaloyl group, isophthaloyl group, terephthaloyl group, naphthoyl group, toluoyl group, hydroatropoly group, atropoyl group, cinnamoyl group, furoyl group, thenoyl group, nicotinoyl group, isonicotinoyl group, p-toluene-sulfonyl group, and mesyl group.

Examples of the cyclic acid-dissociative group may include: cyclopropyl group, cyclopentyl group, cyclohexyl group, cyclohexenyl group, 4-methoxycyclohexyl group, tetrahydropyranyl group, tetrahydrofuranyl group, tetrahydrothiopyranyl group, tetrahydrothiofuranyl group, 3-bromotetrahydropyranyl group, 4-methoxytetrahydropyranyl group, 4-methoxy-tetrahydrothiopyranyl group, and 3-tetrahydrohiophene-1,1-dioxide.

Of these acid-dissociative groups, it is preferred to use benzyl group, t-butoxycarbonylmethyl group, 1-methoxyethyl group, 1-ethoxyethyl group, t-butyl group, trimethylsilyl group, t-butoxycarbonyl group, tetrahydropyranyl group, tetrahydrofuranyl group, tetrahydrothiopyranyl group, and tetrahydrothiofuranyl group. Incidentally, silyl group and germyl group are also the above-dissociative group but are not usable in the present invention.

As the component (D), a compound containing a phenolic hydroxyl group protected by the acid-dissociative group may preferably be used. Examples thereof may include those represented by the following formulas (1)-(6). 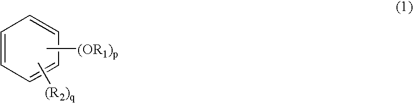
wherein R1 represents the above described acid-dissociative group and each R1 may be the same or different; R2 represents an alkyl group having 1-4 carbon atoms, phenyl group or 1-naphthyl group and each R2 may be the same or different; p is an integer of not less than 1; and q is an integer of not less than 0 with the proviso that p+q≦6. 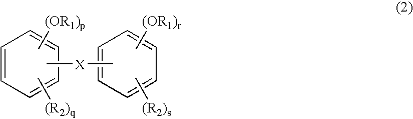
wherein R1 and R2 are the same as those defined in the formula (1); X represents a single bond, —S—, —O—, —CO—, —COO—, —SO—, —SO₂— or —C(R3)₂— where R3 represents hydrogen atom, an alkyl group having 1-6 carbon atoms, an acyl group having 2-11 carbon atoms, phenyl group, or naphthyl group and each R3 may be the same or different; and p, q, r and s are independently an integer of not less than 0 with the proviso that p+q≦5, r+s≦5, and p+r≧1. 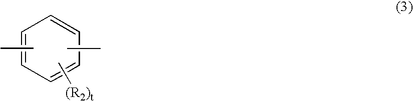
wherein R2 is the same as that in the formula (1); and t is an integer of 0-4. 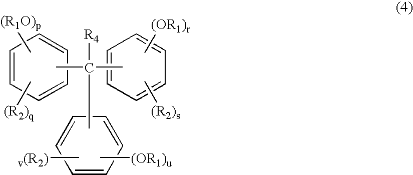
wherein R1 and R2 are the same as those in the formula (1); R4 represents hydrogen atom, an alkyl group having 1-4 carbon atoms; and p, q, r, s, u and v are independently an integer of not less than 0 with the proviso that p+q≦5, r+s≦5, u+v≦5, and p+q+u≧1. 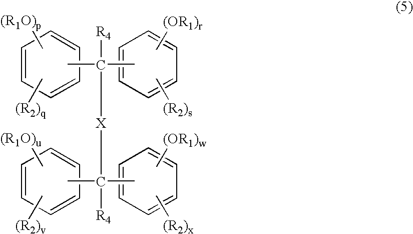
wherein R1 and R2 are the same as those in the formula (1); X in the same as that in the formula (2); R4 is the same as that in the formula (4) and may be the same or different where a plurality of R4 are present; and p, q, r, s, u, v, w and x are independently an integer of not less than 0 with the proviso that p+q≦5, r+s≦5, u+v≦5, w+x≦5, and p+r+u+w≧1. 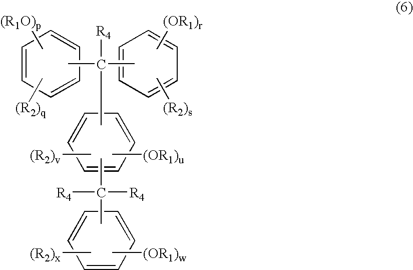
wherein R1 and R2 are the same as those in the formula (1); R4 is the same as that in the formula (4) and may be the same or different where a plurality of R4 are present; and p, q, r, s, u, v, w and x are independently an integer of not less than 0 with the proviso that p+q≦5, r+s≦5, u+v≦5, x+w≦4, p+r+u+w≧1.

As the component (C), compounds represented by the following formulas (7), (8) and (9) are particularly preferred.

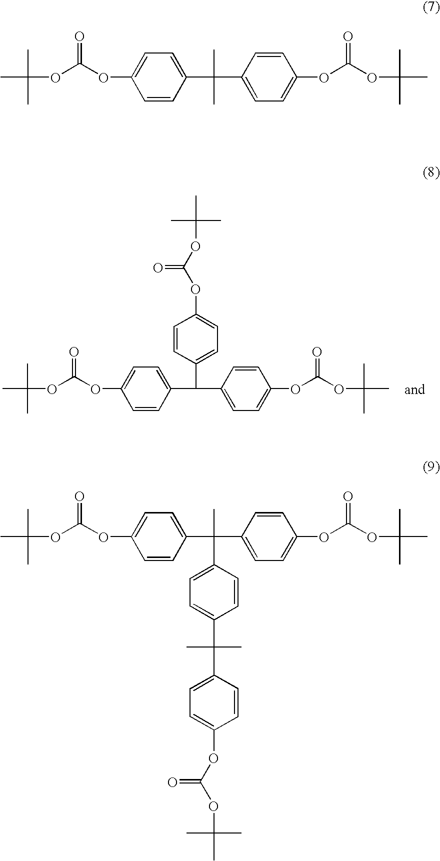

In the photosensitive resin composition in this embodiment, as the component (E), it is possible to add a photosensitizer, whereby it becomes possible to form a pattern at less amount of exposure.

The photosensitizer is a compound which is excited by absorption of light of a specific wavelength and interacts with the above described component (C). Examples thereof may include: a coumarin derivative, a benzophenon derivative, a thioxanthene derivative, an anthracene derivative, a carbazole derivative, and a perylene derivative. The interaction between the photosensitizer and the component (C) may include energy transfer or electron transfer from the photosensitizer in the excited state. The component (E) may preferably have a molar absorption coefficient, with respect to the exposure wavelength, which is larger than that of the component (C).

The resist in this embodiment may further contain known additives, as desired, such as a coloring agent, an adhesive aid, a storage stabilizer, and an antifoaming agent.

Next, contents of the respective components in the resist of this embodiment will be described.

The polymer as the component (A) may preferably be contained in an amount of 5-70 wt. parts, more preferably 25-50 wt. parts, per 100 wt. parts of a total of the component (A) and the component (D). Below 5 wt. %, a film-forming performance is liable to be lowered. On the other hand, above 70 wt. parts, a photosensitivity is liable to be insufficient.

The compound as the component (D) may preferably be contained in an amount of 30-95 wt. parts, more preferably 50-75 wt. parts, per 100 wt. parts of a total of the components (A) and (D). Below 30 wt. parts, the photosensitivity is liable to be insufficient. On the other hand, above 95 wt. parts, the film-forming performance is liable to be lowered.

The acid generation agent as the component (C) and the photosensitizer as the component (E) may preferably be contained in a total amount of 0.01-70 wt. parts, more preferably 0.1-20 wt. parts, per 100 wt. parts of a total of the component (A) and the component (D). Below 0.01 wt. parts, the sensitivity and the resolution are liable to be lowered. On the other hand, above 70 wt. parts, a coating performance and a pattern shape of the resist are liable to be deteriorated.

A weight ratio of the photosensitizer as the component (E) to a total weight of the components (C) and (E) may preferably be 1-90 wt. %, more preferably 5-70 wt. %, particular preferably 10-50 wt. %. In this case, below 1 wt. %, an effect of improvement in sensitivity is liable to be lowered. On the other hand, above 90 wt. %, the resist pattern is less liable to be formed in a rectangular shape.

In this embodiment (second embodiment), it is also possible to appropriately apply the constitutions described in the first embodiment.

Hereinbelow, the present invention will be described more specifically based on Embodiments and Comparative Embodiments.

### Embodiments 1-4 and Comparative Embodiments 1 and 2

In these embodiments, photosensitive resin compositions associated with the above described photosensitive resin composition according to the first aspect of the present invention are prepared in formulations shown in Table 1 below.

TABLE 1

| | | Amount (g) | | | | | |
|---|---|---|---|---|---|---|---|
| | | | | | | | Comp. |
| Component | Material | Emb. 1 | Emb. 2 | Emb. 3 | Emb. 4 | Comp. Emb. 1 | Emb. 2 |

*1

| | | | | | | | |
|---|---|---|---|---|---|---|---|
| (A) | polystyrene | 3 | 0 | 0 | 0 | 0 | 0 |

*2

| | | | | | | | |
|---|---|---|---|---|---|---|---|
| (A) | polystyrene | 0 | 3 | 0 | 0 | 0 | 0 |

*3

| | | | | | | | |
|---|---|---|---|---|---|---|---|
| (A) | polystyrene | 0 | 0 | 1 | 0 | 0 | 0 |

*4

| | | | | | | | |
|---|---|---|---|---|---|---|---|
| (A) | polystyrene | 0 | 0 | 0 | 0 | 3 | 0 |

*5

| | | | | | | | |
|---|---|---|---|---|---|---|---|
| (A) | polystyrene | 0 | 0 | 0 | 0 | 0 | 3 |
| (B) | TM-300 | 7 | 7 | 9 | 10 | 7 | 7 |
| solvent | PGMEA | 90 | 90 | 90 | 90 | 90 | 90 |

*1 Mw = 5200, Mw/Mn = 1.06
*2 Mw = 2200, Mw/Mn = 1.06
*3 Mw = 20000, Mw/Mn = 1.06
*4 Mw = 5800, Mw/Mn = 2.0
*5 Mw = 6500, Mw/Mn = 2.5

Each of the above prepared resist solutions is applied onto a silicon substrate and pre-baked on a hot plate at 100° C. for 60 sec., to form a resist layer having a thickness of 1.0 micron.

The substrate is imagewise exposed to light by i-ray stepper (wavelength=365 nm) as an exposure apparatus.

The exposed substrate is then immersed in a sylylation solution, which comprises 10 wt. % of hexamethylcyclotrisilazene (sylylating agent), 87 wt. % of a n-decane, and 3 wt. % of diethylene glycol dimethyl ether, for 2 minutes at room temperature, followed by rinsing in n-decane, thus selectively form a sylylation layer as a surface layer of an exposure portion of the resist layer-formed substrate.

Thereafter, the thus treated substrate is subjected to oxygen plasma etching to form a resist pattern.

For each of the above formed resist patterns, a resolution is evaluated as a minimum value of spacings between lines of resist pattern which is neatly formed by removing an unexposed portion through dry development without causing any partial or capable exfoliation (or peeling). A smaller resolution value means a better resolution. Measurement of LER (3 σ) is performed by a scanning electron microscope.

With respect to the resolution, the resist patterns formed in Embodiments 1-4 and Comparative Embodiment 1 provide good resolutions but the resist pattern formed in Comparative Embodiment 2 fails to provide a resolution of not more than 2.0 microns.

With respect to the LER, the resist patterns formed in Embodiments 1-4 provide LER smaller than that in Comparative Embodiment 1. This is because in Comparative Embodiment 1, a dispersion state of the component (B) is nonuniform and a spatial distribution of a resistance to oxygen dry etching at the exposure portion is large. As for the resist pattern formed in Comparative Embodiment 2, evaluation of the LER cannot be effected since it does not provide the resolution of not less than 2.0 microns.

### Embodiments 5-7 and Comparative Embodiments 3 and 4

In these embodiments, photosensitive resin compositions associated with the above described photosensitive resin composition according to the second aspect of the present invention are prepared in formulations shown in Table 1 below.

TABLE 2

| | | Amount (g) | | | | |
|---|---|---|---|---|---|---|
| | | | | | Comp. | Comp. |
| Component | Material | Emb. 5 | Emb. 6 | Emb. 7 | Emb. 3 | Emb. 4 |

*1

| | | | | | | |
|---|---|---|---|---|---|---|
| (A) | polystyrene | 7 | 0 | 0 | 0 | 0 |

*2

| | | | | | | |
|---|---|---|---|---|---|---|
| (A) | polystyrene | 0 | 7 | 0 | 0 | 0 |

*3

| | | | | | | |
|---|---|---|---|---|---|---|
| (A) | polystyrene | 0 | 0 | 8 | 0 | 0 |

*4

| | | | | | | |
|---|---|---|---|---|---|---|
| (A) | polystyrene | 0 | 0 | 0 | 7 | 0 |

*5

| | | | | | | |
|---|---|---|---|---|---|---|
| (A) | polystyrene | 0 | 0 | 0 | 0 | 7 |
| (C) | triphenyl- | 0.5 | 0.5 | 0.5 | 0.5 | 0.5 |
| | sulfonium- | | | | | |
| | trifluoromethane | | | | | |
| | sulfonate | | | | | |
| (D) | compound of | 3 | 3 | 2 | 3 | 3 |
| | (7) | | | | | |
| (E) | 2,4-diethyl-thioxanthene | 0.1 | 0.1 | 0.1 | 0.1 | 0.1 |
| solvent | PGMEA | 90 | 90 | 90 | 90 | 90 |

*1 Mw = 5200, Mw/Mn = 1.06
*2 Mw = 2200, Mw/Mn = 1.06
*3 Mw = 20000, Mw/Mn = 1.06
*4 Mw = 5800, Mw/Mn = 2.0
*5 Mw = 6500, Mw/Mn = 2.5

Each of the above prepared resist solutions is applied onto a silicon substrate and pre-baked on a hot plate at 100° C. for 60 sec., to form a resist layer having a thickness of 1.0 micron.

The substrate is imagewise exposed to light by i-ray stepper (wavelength=365 nm) as an exposure apparatus. After the exposure, the substrate is heated on the hot plate at 100° C. for 60 sec.

The exposed substrate is then immersed in a sylylation solution, which comprises 10 wt. % of hexamethylcyclotrisilazene (sylylating agent), 87 wt. % of a n-decane, and 3 wt. % of diethylene glycol dimethyl ether, for 2 minutes at room temperature, followed by rinsing in n-decane, thus selectively form a sylylation layer as a surface layer of an exposure portion of the resist layer-formed substrate.

Thereafter, the thus treated substrate is subjected to oxygen plasma etching to form a resist pattern.

For each of the above formed resist patterns, a resolution is evaluated as a minimum value of spacings between lines of resist pattern which is neatly formed by removing an unexposed portion through dry development without causing any partial or capable exfoliation (or peeling). A smaller resolution value means a better resolution. Measurement of LER (3 σ) is performed by a scanning electron microscope.

With respect to the resolution, the resist patterns formed in Embodiments 5-7 and Comparative Embodiment 1 provide good resolutions but the resist pattern formed in Comparative Embodiment 2 fails to provide a resolution of not more than 2.0 microns.

With respect to the LER, the resist patterns formed in Embodiments 5-7 provide LER smaller than that in Comparative Embodiment 3. This is because in Comparative Embodiment 3, a dispersion state of the component (B) is nonuniform and a spatial distribution of a resistance to oxygen dry etching at the exposure portion is large. As for the resist pattern formed in Comparative Embodiment 4, evaluation of the LER cannot be effected since it does not provide the resolution of not less than 2.0 microns.

While the invention has been described with reference to the structures disclosed herein, it is not confined to the details set forth and this application is intended to cover such modifications or changes as may come within the purpose of the improvements or the scope of the following claims.

This application claims priority from Japanese Patent Applications Nos. 083234/2004 filed Mar. 22, 2004, 083353/2004 filed Mar. 22, 2004, and 219144/2004 filed Jul. 27, 2004, which are hereby incorporated by reference.

1.-7. (canceled)

8. A method of forming a resist pattern, comprising:
a lamination step of laminating on a substrate a layer of a photosensitive resin composition comprising component (A) and component (B) wherein component A is polystyrene having a molecular weight dispersion of weight-average molecular weight to number-average molecular weight (Mw/Mn) of 1.0-1.5 and compound A is a compound first generating a functional group capable of being silylated by irradiation,
an exposure step of selectively exposing the photosensitive resin composition layer to radiation to form an exposure portion,
a sylylation step of sylylating the exposure portion with a sylylating agent, and
a developing step of removing the photosensitive resin composition layer through dry etching with oxygen plasma while leaving a sylylated area.

9. A method of forming a resist pattern, comprising:
a lamination step of laminating a component (B) alone on a substrate,
an exposure step of selectively exposing a layer of a photosensitive resin composition comprising component (A) and component (B) wherein component A is polystyrene having a molecular weight dispersion of weight-average molecular weight to number-average molecular weight (Mw/Mn) of 1.0-1.5 and compound A is a compound first generating a functional group capable of being silylated by irradiation,
a sylylation step of sylylating the exposure portion with a sylylating agent, and
a developing step of removing the photosensitive resin composition layer through dry etching with oxygen plasma while leaving a sylylated area.

10. A method according to claim 9, wherein said component (B) is a compound containing 1,2-naphthoquinone diazido group.

11. A method of processing a substrate, comprising:
a step of forming a resist pattern on a work substrate, to be processed, by a method of forming a resist pattern according to claim 8, and
a step of effecting dry etching, wet etching, metal vapor deposition, lift-off, or plating with respect to the work substrate.

12. A device manufacturing method, comprising:
a step of preparing an exposure mask on which a pattern is formed on the basis of device designing, and
a step of forming a pattern on a substrate, for manufacturing a device, by a method of processing a substrate according to claim 11.

13.-16. (canceled)

17. A method of forming a resist pattern, comprising:
a lamination step of laminating on a sylylat a layer of a photosensitive resin composition comprising component A, component C, and component D wherein Component A is a polystyrene having a molecular weight dispersion of weight average molecular weight to number-average molecular weight (Mw/Mn) of 1.0-1.5,
Component C is a radiation-sensitive acid generator agent, and
Component D is a compound emitting at least one of hydroxyl, carboxyl amino, thiol or amido, each which is protected by an acid-dissociative group.
an exposure step of exposing a predetermined portion of the photosensitive resin composition layer to active light ray to form an exposure portion,
a sylylation step of sylylating the exposure portion, and
a dry development step of removing a portion other than the exposure portion of the photosensitive resin composition layer by oxygen plasma.

18. A method of processing a substrate, comprising:
a step of forming a resist pattern on a substrate by a method of forming a resist pattern according to claim 16, and
a step of effecting dry etching, wet etching, metal vapor deposition, lift-off, or plating with respect to the substrate.

19. A device manufacturing method, comprising:
a step of preparing an exposure mask on which a pattern is formed on the basis of device designing and
a step of forming a pattern on a substrate, for manufacturing a device, by a method of processing a substrate according to claim 18.
